(19) United States
(12) Patent Application Publication
(10) Pub. No.: US 2024/0081372 A1
(43) Pub. Date: Mar. 14, 2024

(54) High Fat Extruded Protein Product and Method of Making

(71) Applicant: General Mills, Inc., Minneapolis, MN (US)

(72) Inventors: Andriana V. Schirack, Plymouth, MN (US); Goeran Walther, Plymouth, MN (US); Robert J. Harrison, Champlin, MN (US); Benjamin Lee Heitke, Corcoran, MN (US)

(73) Assignee: General Mills, Inc., Minneapolis, MN (US)

(21) Appl. No.: 17/942,405

(22) Filed: Sep. 12, 2022

(51) Int. Cl. A23J 3/26; A23J 3/04; A23J 3/16; A23J 3/18; A23J 3/22; A23L 13/40; A23L 13/60; A23P 20/10; A23P 20/15

(52) U.S. Cl. CPC A23J 3/26; A23J 3/04; A23J 3/16; A23J 3/18; A23J 3/227; A23L 13/426; A23L 13/67; A23P 20/11; A23P 20/15; A23V 2002/00

(57) ABSTRACT

A method of preparing a high fat extruded protein product includes feeding water, a first fat, and a blend of plant proteins to an extruder to produce an extruded protein mixture. The extruded protein mixture is directed through a cooling die and divided into pieces, with the pieces being subsequently tumbled with oil. The resulting high fat extruded protein product will have at least 15-23% total fat by weight and, upon cooking, exhibits a desirable grease-out effect (e.g., reminiscent of a traditional pepperoni product). The blend of plant proteins preferably includes soy protein, wheat gluten and a grain or starch-based ingredient, and makes up at least 40-50%, by weight, of the high fat extruded protein product.

### FIELD OF THE INVENTION

The present invention generally pertains to extruded protein products and methods of making extruded protein products. More specifically, the invention further relates to extruded protein products having a high fat content and methods of achieving a high fat content in extruded protein products.

### BACKGROUND OF THE INVENTION

Meat products such as pepperoni, sausage, ham, etc. have been and continue to be popular products used to add flavor to many culinary dishes such as pizza. However, ingredient costs are a concern in producing a batch of meat products and the limit is being reached in streamlining costs based on a standard meat block. For example, producing a batch of pepperoni or dry/semi-dry sausage products, typically made from pork and beef (or in some cases, poultry), traditionally involves multiple steps and requires multiple days. An example of such a process is shown in FIG. 1, wherein a raw meat material 1 (e.g., pork, beef and/or poultry) is coarsely ground 3 before additional ingredients 4 are mixed therewith (e.g., salt and curing agents, acid-producing cultures and/or acidulants, seasoning, optional binders) to form an intermediate mixture 11. Of course, the types of meat and additional ingredients employed depend upon the type of product desired. Intermediate mixture 11 is then finely ground 12 and formed or extruded 13 into casings. The shaped materials then undergo fermentation 14 until, e.g., if applicable, a certain pH is achieved (e.g., a pH below 5.2, a pH between 4.6 and 5.0) and fermentation is stopped. The fermented material is cooked 15 and then dried 16 (if applicable), size adjusted 17 (e.g., sliced or diced) and frozen 18 (if applicable). Traditionally made pepperoni or like products contain approximately 30-35% fat, have a very fatty mouthfeel and a high intensity of flavor carried on the fat. A characterizing attribute of pepperoni or like products, and one expected by consumers, is fat exuding therefrom during cooking (also known as “grease-out”), a phenomenon commonly experienced in cooking and consuming, e.g., a pepperoni pizza.

As a result of the multi-step process, pepperoni or like products are costly to prepare. Of course, particularly for food manufacturers, ingredient costs are a concern in producing a batch of meat-containing pepperoni or like products. In addressing this concern, it has been proposed to employ cost-effective plant proteins to deliver a product with an analogous meat-like texture and function of traditional meat products. In fact, extrusion technology has been utilized to produce protein products that have an enjoyable texture, while eliminating the use of animal protein. Overall, these products are intended to mimic whole or ground meat and are meant to be eaten in place of meat. Advantageously, extrusion technology can enable a continuous production process. However, as the amount of fat that can be incorporated and stabilized during extrusion is limited, a common issue in extruded protein products is the difficulty in achieving fat levels over 10%. Typically, extruded protein products achieve levels of 6-8% fat. When high levels of fat are attempted (e.g., attempting to increase the fat content from 6% to 14%), considerable leakage of unincorporated fat occurs at the outlet of the extruder, thereby reducing the potential fat level of the final product. In the case of, for example, a pepperoni substitute, not being able to achieve the desired fat level of the final product prevents the final product from exhibiting the desirable grease-out attribute.

### SUMMARY OF THE INVENTION

Provided herein is a method of preparing a high fat extruded protein product, as well as the protein product produced. The method includes a step of feeding water, a first fat, and a blend of plant proteins to an extruder to produce an extruded protein mixture. The extruded protein mixture is divided into pieces and the pieces are tumbled with oil. Preferably, the high fat extruded protein product will have at least 15-23% total fat by weight and, upon cooking, exhibits a grease-out effect (e.g., reminiscent of a traditional pepperoni product).

In some embodiments, the blend of plant proteins includes soy protein, wheat gluten and additionally can contain a grain or starch-based ingredient, such as rice flour or oat flour. Preferably, the high fat extruded protein product comprises at least 40-50% of the blend of plant proteins by weight. In certain embodiments, the blend of plant proteins is a dry mix, to which fat and water are subsequently added.

In preferred embodiments, the method of preparing a high fat extruded protein product further includes a step of cooling the extruded protein mixture by passing the extruded protein mixture through a cooling die. Preferably, the melting point of the fat fed to the extruder is higher than the temperature of the cooling die. Preferably, the method of preparing a high fat extruded protein product includes maintaining a temperature of the cooling die lower than a melting point of the fat fed to the extruder and cooling down the protein mixture (or product) to temperatures lower than a melting point of the fat fed to the extruder.

In some embodiments, tumbling the extruded pieces with oil includes vacuum tumbling the extruded pieces with oil.

In some embodiments, after tumbling the pieces with oil, the method of preparing the high fat extruded protein product includes freezing the pieces.

In another embodiment, the method includes adding a second fat during a later stage of extrusion to establish fat pockets in the pieces.

In some embodiments, the method of preparing a high fat extruded protein product includes cooking the pieces, whereupon the pieces exhibit a grease out attribute (e.g., similar to pepperoni). Certainly, any or all of these embodiments can be combined.

A high fat extruded protein product of the present invention can include a blend of plant proteins including soy protein, wheat gluten and additionally can contain a grain or starch-based ingredient, such as rice or oat flour, and at least 15-23% total fat by weight wherein, upon cooking the product, the product exhibits a grease-out effect (e.g., reminiscent of a traditional pepperoni product). Optionally, the product can further comprise meat, wherein the meat constitutes no greater than 30% by weight of the high fat extruded protein product. Preferably, the blend of plant proteins constitutes at least 40-50% by weight of the high fat extruded protein product. In one embodiment, at least part of the total fat is from infused oil. In another embodiment, at least part of the total fat is from tempered lard. In yet another embodiment, at least part of the total fat is from hard fat which establish fat pockets in the protein product.

### BRIEF DESCRIPTION OF THE DRAWINGS

FIG. 1 is a flow diagram of a prior art process for producing traditional pepperoni or dry/semi-dry sausage products.

FIG. 2 is a flow diagram of a process for producing a high fat extruded protein product in accordance with a preferred embodiment of the present invention.

FIG. 3 is a schematic of an apparatus for producing a high fat extruded protein product in accordance with a preferred embodiment of the present invention.

FIG. 4 is a chart illustrating the effect of a plant protein blend in accordance with embodiments of the present invention upon the fat percentage obtained in an extruded protein product.

FIG. 5 is a chart illustrating the effect of a specified order of addition in accordance with embodiments of the present invention upon the fat percentage obtained in an extruded protein product.

FIG. 6 is a chart illustrating the effect of tumbling or vacuum tumbling in accordance with embodiments of the present invention upon the fat percentage obtained in an extruded protein product.

FIGS. 7-9 are micrographs of extruded protein product pieces produced with a plant protein blend, order of addition and a cooling die in accordance with embodiments of the present invention. The pieces of FIGS. 8 and 9 are optimized with post-extrusion tumbling, while the piece of FIG. 7 is not.

FIG. 10 is a chart illustrating the synergistic effect of various parameters in accordance with embodiments of the present invention upon the fat percentage obtained in an extruded protein product.

FIG. 11 is a micrograph of an extruded protein product piece not made in accordance with the present invention.

FIG. 12 is a micrograph of an extruded protein product piece produced in accordance with the present invention.

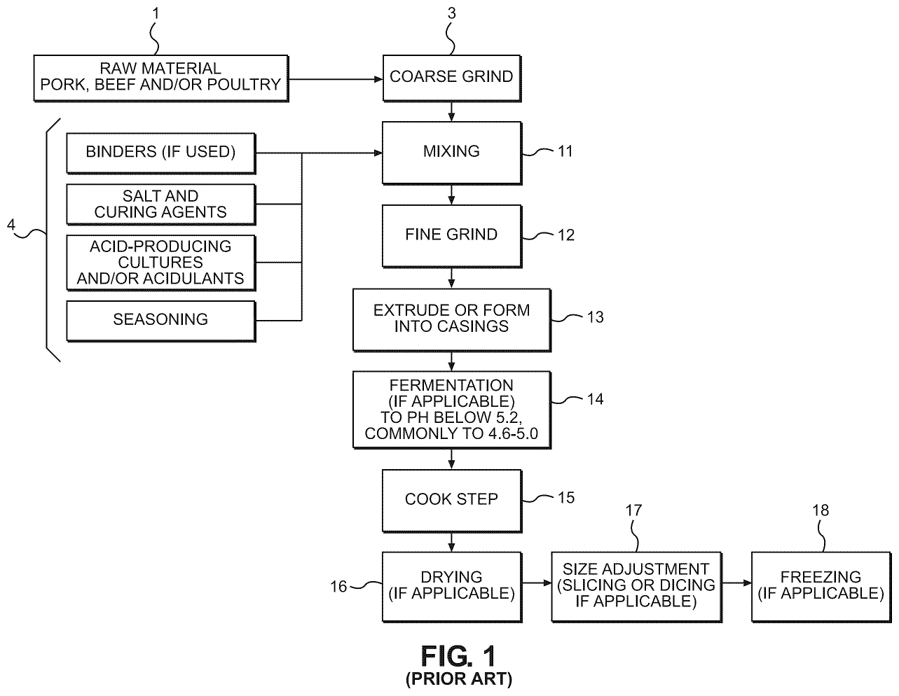

### DETAILED DESCRIPTION

Detailed embodiments of products and methods are disclosed herein. However, it is to be understood that the disclosed embodiments are merely exemplary of the methods, which may be embodied in various forms. Therefore, specific functional details disclosed herein are not to be interpreted as limiting, but merely as a basis for the claims as a representative example for teaching one skilled in the art to variously employ the present disclosure.

As used herein, “about,” “approximately” and “substantially” are understood to refer to numbers in a range of numerals, for example the range of −10% to +10% of the referenced number, preferably −5% to +5% of the referenced number and more preferably −1% to +1% of the referenced number. All percentages expressed herein are by weight.

The continuous process provided herein is capable of forming an extruded protein product having a high fat profile (e.g., to match that of pepperoni) and saves costs compared to the conventional process of making analogous meat products. As used herein, the term “extruded protein product” refers to a food product, or pieces thereof, which has all or a majority of its overall protein from non-animal protein sources, resembles a meat product made from a majority of animal protein, and has at least some ingredients brought together via an extrusion process. The extruded protein product may optionally include animal protein from meat. The extruded protein product may use vegetable protein such as soy protein and gluten to help achieve the appearance, texture and physical structure of a meat product. Preferably, the extruded protein product of the invention is produced in a manner which establishes fat deposits within voids of the product's protein structure. As will be described in more detail below, the invention encompasses a synergistic combination of particular process and ingredient parameters that result in a cost-effective and high fat extruded protein product. As used herein, the term “high fat extruded protein product” refers to an extruded protein product having a high total fat level (e.g., the combination of fat and oil together), specifically at least 15-23% total fat by weight, with the resulting high fat protein product having a “grease out” attribute.

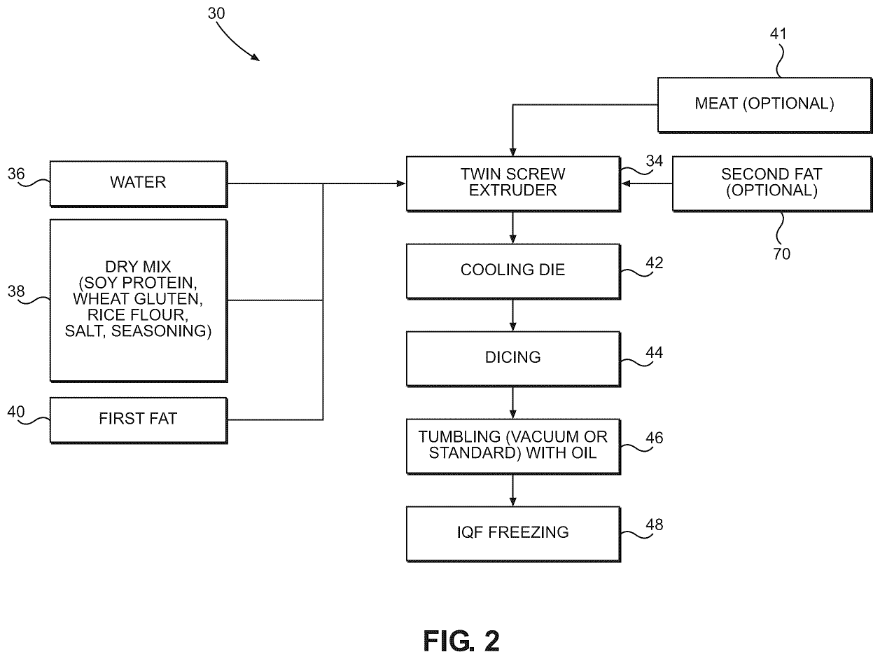

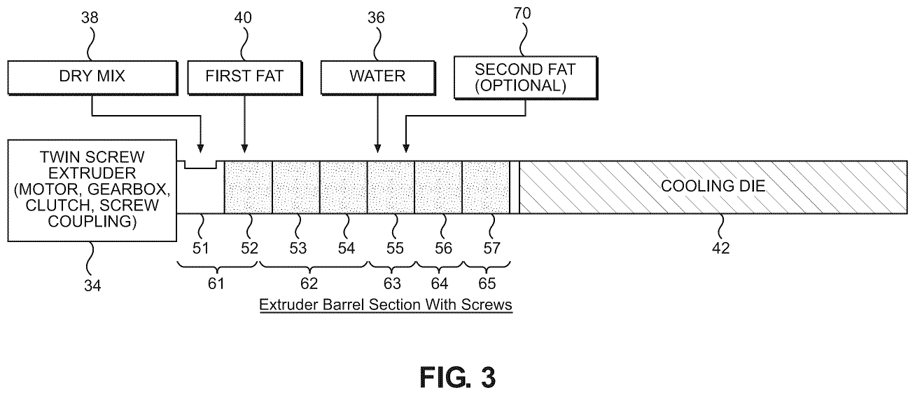

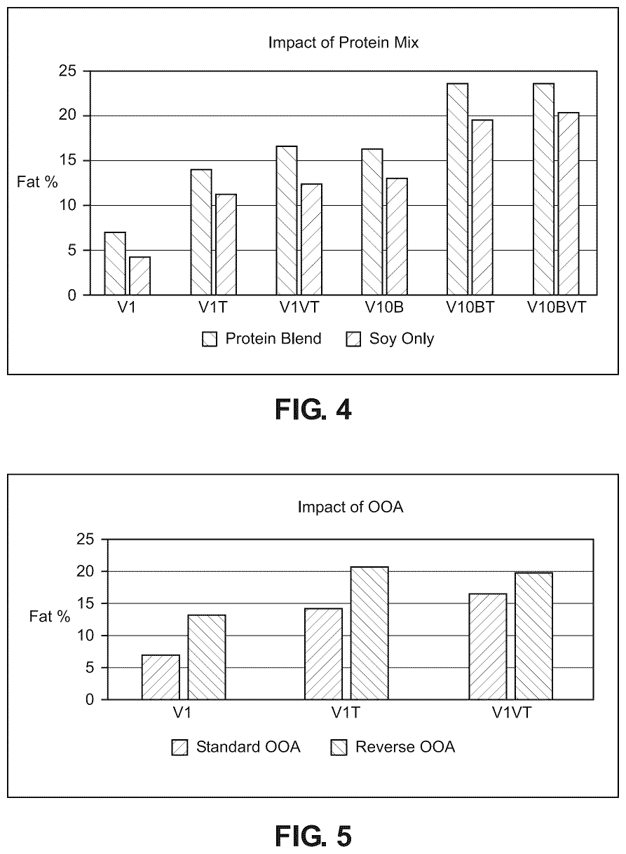

A process according to the present invention is generally indicated at 30 in FIG. 2. In the preferred embodiment, process 30 begins with feeding to a twin screw extruder 34 water 36, a dry mix 38 and first fat 40 (and optionally meat 41). The order of addition of these ingredients to the extruder is detailed below with reference to FIG. 3. Preferably, if included meat 41 is cost-effective meat such as mechanically separated chicken. However, other types of animal protein providing meat 41 could be employed, depending on the desired product, as well as the desired cost. In preferred embodiments, if included at all, meat constitutes no greater than 30% by weight of the high fat extruded protein product. More importantly, dry mix 38 is formulated with a plant protein component which preferably makes up at least 40-50% by weight of the extruded protein product. In particular, the plant protein component of dry mix 38 is a blend of plant proteins including soy protein, wheat gluten and additionally can contain a grain or starch-based ingredient, such as rice flour. At this point, it should be noted that a dry mix including only wheat gluten as the plant protein component is not desired, i.e., would not produce a functional extruded protein product for purposes of the invention. Without being bound by theory, it is considered that a strong protein structure is needed to enable higher fat levels for the extruded protein product. In accordance with a highly preferred form of the invention, a strong protein structure, as well as a desired texture, is achieved by optimizing the plant protein component for the soy protein in combination with wheat gluten, with the addition of a grain or starch-based ingredient, such as rice flour. As evidenced by the chart shown in FIG. 4 which shows results for experimental extruded protein products (e.g., “V1”, “V1T”, etc.), the use of the protein blend of the preferred embodiment of the invention (mainly soy protein and wheat gluten as the main protein sources, and additionally a grain or starch-based ingredient, such as rice flour, which mainly is added as a binder) has a significant impact upon the percentage of fat achieved in the extruded protein product compared to the use of soy only as the plant protein component. Other minor ingredients, such as salt, seasoning and color ingredients, as well as acids for curing, can also be added.

Returning to FIG. 2, first fat 40 preferably includes tempered lard as a fat source in process 30, but other fats may be used. Preferably, the fat source is an animal fat having a relatively high melting point such as those shown in Table 1 (from Trushenski et al. Potential, Implications and Solutions Regarding the Use of Rendered Animal Fats in Aquafeeds. American Journal of Animal and Veterinary Sciences 4(4), April 2009.)

TABLE 1

| | | | Tallow | Choice | |
|---|---|---|---|---|---|
| | Poultry | | (beef or | white | Yellow |
| | fat | Lard | mutton) | grease | grease |
| Melting | 35.36 | 36-42 | 44.72 | 32.5 | 33.87 |
| point (° C.) | | | | | |

In accordance with preferred embodiments of the invention, and as shown in FIG. 3, water 36 and first fat 40 are added to twin screw extruder 34 in a unique order, actually a reverse order of addition (“OOA”) than previously employed. More specifically, fat is added to the dry mix first, followed by a late stage extruder water addition, as opposed to prior extrusion addition sequences of either the simultaneous addition of water and fat/oil or a later stage oil addition. In a preferred embodiment shown, twin screw extruder includes seven barrels 51-57 which are grouped into five zones 61-65. While a twin screw extruder is preferred, another known type of extruder that applies a high amount of shear and mixing could alternatively be employed. Extruder 34 applies a force forward conveying to the provided ingredients to move the ingredients from an inlet to an outlet. In first zone 61, dry mix 38 is added to first barrel 51, which is an open barrel, with no heating and first fat 40 (e.g., liquid fat) is added through injection ports in second barrel 52. In second zone 62, mixing occurs at high shear and high heat in second barrel 52 (180-220° F.) and in third and fourth barrels 53,54 (290-350° F.). In third zone 63, water is injected using an injector in fifth barrel 55 and an optional second fat 70 can be added. A second fat in the form of, e.g., fat chips or other hard fat may be added at this stage of the extrusion process to create fat blocks intended to simulate “fat pockets” traditionally seen in high fat meat products. If an optional second fat 70 is added, it can be added via an open feed port in barrel 55, or alternatively via a side feeder connected to barrel 55. In fourth zone 64, minimal mixing occurs at low shear and lower temperatures in sixth and seventh barrels 56,57 (100-190° F.) to develop a cohesive dough/protein mixture. Lastly, in fifth zone 65, pressure is built up and the dough/protein mixture is compressed and transitioned into cooling die 42. Table 2 shows exemplary temperatures for barrels 51-57 during the process of the present invention (Reverse OOA) compared to barrels during standard OOA.

TABLE 2

| | Standard | Reverse |
|---|---|---|
| | OOA | OOA |
| | ° F. | ° F. |
| Barrel 51 | Room | Room |
| Temperature | temperature | temperature |
| Barrel 52 | 180 | 190 |
| Temperature | | |
| Barrel 53 | 210 | 350 |
| Temperature | | |
| Barrel 54 | 250 | 350 |
| Temperature | | |
| Barrel 55 | 290 | 190 |
| Temperature | | |
| Barrel 56 | 290 | 190 |
| Temperature | | |
| Barrel 57 | 200 | 190 |
| Temperature | | |

The above-described reverse OOA has actually been found to significantly impact the ability to advantageously increase the percentage of fat retained in the extruded protein product. More specifically, as evidenced by the chart shown in FIG. 5 showing results for experimental extruded protein products (e.g., “V1”, “V1T”, etc.), the reverse OOA in accordance with the most preferred embodiment of the invention has a significant impact upon the final percentage of fat achieved in the extruded protein product compared to a standard or conventional OOA. Without being bound by theory, it is considered that combining the dry mix with fat (e.g., first fat 40) in an early stage of the extrusion process and without water allows for more rigorous mixing that causes the fat to penetrate and bind with the developing protein matrix. The subsequent addition of water occurs with slight mixing, just enough to blend without excess shear so as to avoid displacing the fat from the developing protein product. The fat desirably does not leak out upon exiting the extruder.

Cooling occurs before or simultaneously with the injection of water 36 (e.g., the water does some of the cooling, and the barrel temperatures in barrels 55-57 can be adjusted, such as between 100-190° F., to provide additional cooling) such that the optional second fat 70 added to simulate fat pockets in the extruded protein product does not melt, or only experiences partial melting, but rather gets blended as chunks of fat. Other ingredients may be incorporated into the extruded protein product as needed (e.g., via injection port). For example, emulsifiers (e.g., oil- or water-soluble emulsifiers or combinations thereof; lecithin, mono- and diglycerides or the like) employed to drive higher fat levels in the extruded protein product or proteins with high fat binding capacity could be included. Such proteins would preferably be used at a lower rate than the texturing plant protein component of dry mix 38 described above.

Returning to FIGS. 2 and 3, at the outlet of extruder 34, a cooling die 42 applies cooling to the extruded protein mixture. Cooling die 42 may be maintained at a constant temperature. Preferably, cooling die 42 is maintained at a temperature less than a melting point of the fat(s) fed to the extruder. Alternatively, cooling die 42 may exhibit a temperature profile along the path of the mixture as the extrudate moves through cooling die 42. For this purpose, cooling die 42 may contain one or more integrated cooling circuits, as well as one or more temperature sensors to sense temperature(s) within cooling die 42. It is considered that the high amounts of plant protein (e.g., at least 40-50% plant protein by weight of the extruded protein product) employed in the invention are enabled, at least in part, due to the high amount of shear and heat in the first part of extruder 34 (i.e., in barrels 51-54) and cooling with minimal mixing provided in the second part of extruder 34 (i.e., barrels 55-57) and cooling die 42. Overall, this combination of features enhances the creation and/or maintaining of cracks and voids in the protein structure which, in turn, enables high fat/oil uptake in the finished product. Further, in the extruded protein mixture fat is distributed throughout and at its surface and remains solids and does not leak out due to the above-described cooling features.

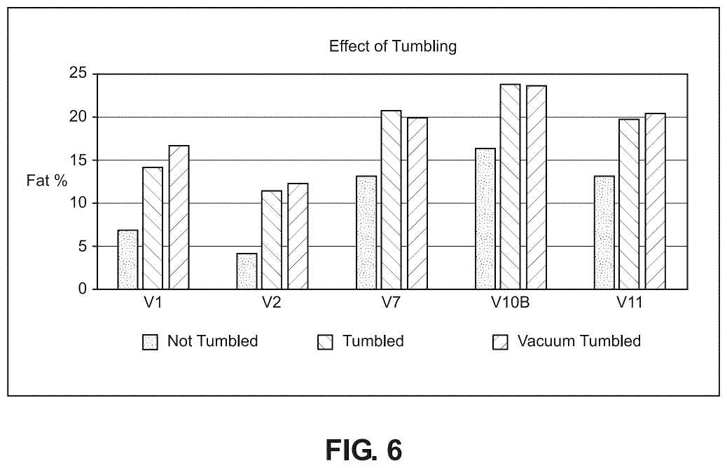

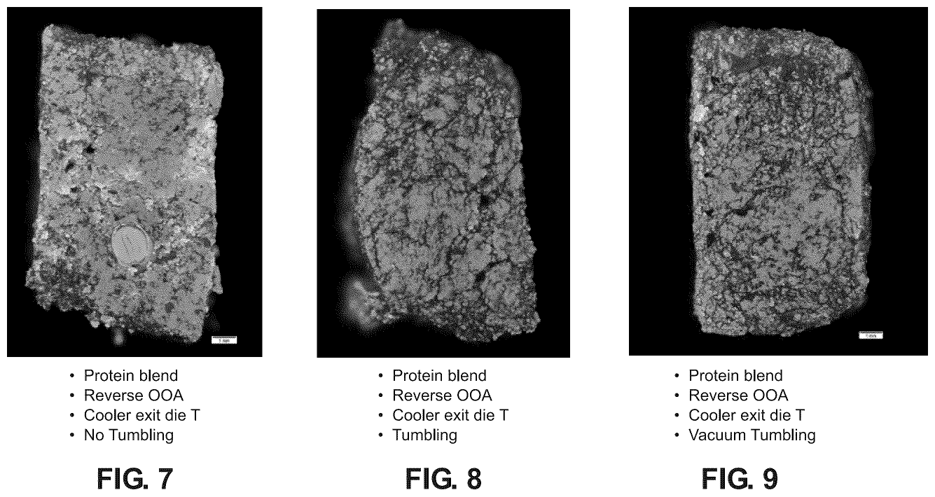

The extruded protein mixture exiting cooling die 42 is then diced at 44 or otherwise divided into extruded protein product pieces of a desired shape and size. The pieces of extruded protein product are then tumbled with an oil at 46. This tumbling particularly functions to drive additional fat (in the form of oil) into the interior of the pieces (e.g., into the above-mentioned cracks and voids in the protein structure). Vacuum tumbling has been found to even further increase this oil infusing operation. Although a wide range of oils could be employed and may be animal-based or plant-based, the oil is to be edible and liquid at room temperature. The actual oil selection can be based on, for example, nutritional profile, compatibility with the extrusion process and/or equipment, desired texture and/or mouthfeel imparted to the extruded piece, and/or price. As evidenced by the chart shown in FIG. 6 which shows results for experimental extruded protein products (e.g., “V1”, “V2”, etc.), the addition of tumbling or vacuum tumbling in oil as done in the preferred embodiment of the invention has a significant impact upon the percentage of total fat achieved in the extruded protein product compared to no tumbling. The results of FIG. 6 are supplemented by the micrographs of FIGS. 7-9 in which the darker areas of the extruded protein product pieces represent visible fat. Each of the pieces of FIGS. 7-9 was made using the above-mentioned preferred plant protein blend, reverse OOA and cooler exit temperature. However, FIGS. 8 and 9 differ from FIG. 7 in that tumbling or vacuum tumbling, respectively, are performed on the extruded protein product pieces. Clearly, tumbling or vacuum tumbling results in a higher uptake of fat in the extruded protein product. Lastly in process 30 of FIG. 2, the tumbled extruded protein product pieces are preferably frozen (e.g., via Individual Quick Freezing (IQF)).

In some embodiments, the method of preparing a high fat extruded protein product includes cooking the extruded protein pieces, whereupon the pieces exhibit a desirable grease out attribute.

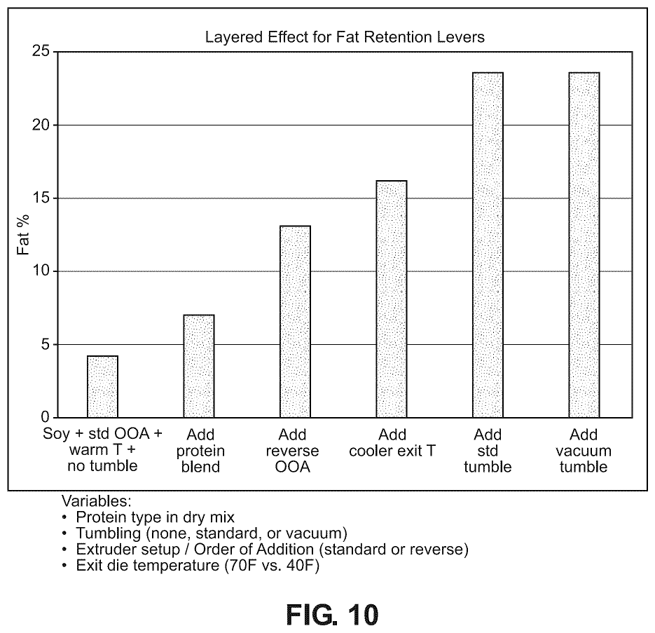

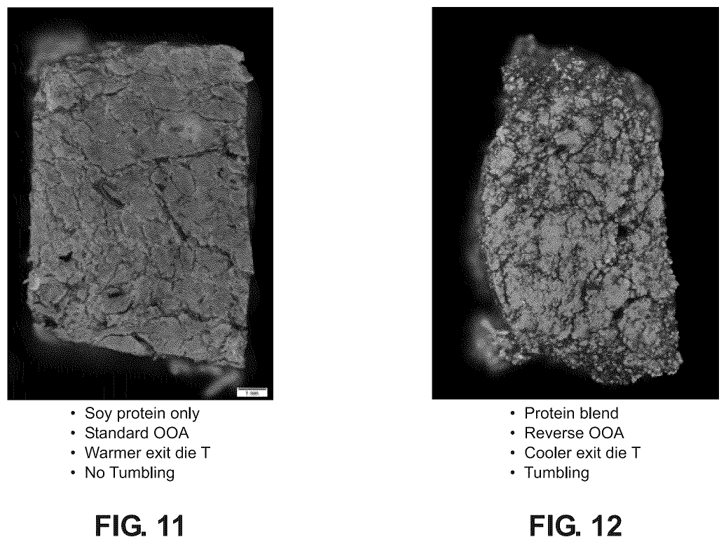

As described above, a series of individual operations in the production of an extruded protein product were found to have a significant impact in establishing a high percentage of fat in the resulting extruded protein product (e.g., an optimized plant protein blend, a reverse OOA, cooling temperature control and tumbling in oil). Actually, a synergistic effect was evident when combining two or more of the above-mentioned parameters as best illustrated by the chart of FIG. 10. For example, the combination of the preferred plant protein blend, the reverse OOA and the application of lower temperatures through cooling die 42 could achieve an extruded protein product having at least 15% by weight total fat. An increase to over 20% total fat by weight can be achieved by further adding a tumbling step (total fat includes tumbling oil). Total fat levels of at least 15-23% obtained by the present invention are considerably higher than the typical 6-8% obtained in other extruded protein products and achieve the desirable “grease out” characteristic. The results of FIG. 10 are accompanied by the micrographs of FIGS. 11 and 12 in which the dark areas of the extruded protein product pieces represent visible fat. The piece of FIG. 12 was made via the above-mentioned overall combination of parameters, while the piece of FIG. 11 was not made via the above-mentioned combination of parameters. Clearly, the above-mentioned combination of parameters results in a significantly higher uptake of fat in the extruded protein product. As mentioned above, an optional latter stage second fat addition step can further increase the final/total fat percentage. In addition to this advantage, the overall process of the invention represents a continuous production process, particularly a streamlined and cost-effective process for producing an extruded protein product having high fat content which enables the resulting, high fat extruded protein product to, upon cooking, successfully exhibit the desirable grease-out attribute. Although described with reference to preferred embodiments of the invention, the invention is only intended to be limited by the scope of the following claims.

1. A method of preparing a high fat extruded protein product, comprising:
feeding water, a first fat, and a blend of plant proteins to an extruder to produce an extruded protein mixture;
dividing the extruded protein mixture into pieces; and
tumbling the pieces with oil to drive the oil into the pieces.

2. The method of claim 1, wherein the blend of plant proteins includes soy protein, wheat gluten and a grain or starch-based ingredient.

3. The method of claim 2, wherein the blend of plant proteins consists of soy protein, wheat gluten and rice flour.

4. The method of claim 2, further comprising feeding meat to the extruder, wherein the meat constitutes no greater than 30% by weight of the high fat extruded protein product and the blend of plant proteins constitutes at least 40-50% by weight of the high fat extruded protein product.

5. The method of claim 1, wherein the blend of plant proteins is a dry mix and the first fat is mixed with the dry mix prior to the water.

6. The method of claim 1, further comprising cooling the extruded protein mixture by passing the extruded protein mixture through a cooling die.

7. The method of claim 6, wherein passing the extruded protein mixture through a cooling die includes maintaining a temperature of the cooling die lower than a melting point of the first fat.

8. The method of claim 1, wherein tumbling the pieces with oil includes vacuum tumbling the pieces with oil.

9. The method of claim 1, wherein the first fat and the oil together comprise 15-23% by weight of the high fat extruded protein product.

10. The method of claim 1, further comprising, after tumbling the pieces with oil, freezing the pieces.

11. The method of claim 1, further comprising, cooking the pieces, whereupon the pieces exhibit a grease out attribute.

12. The method of claim 11, further comprising adding a second fat during a later stage of extrusion to establish fat pockets in the pieces.

13. The method of claim 1, wherein the blend of plant proteins is a dry mix and includes soy protein, wheat gluten and a grain or starch-based ingredient, the first fat is mixed with the dry mix, water is only added in a late stage, and the first fat and the oil together comprise 15-23% by weight of the high fat extruded protein product.

14. The method of claim 13, further comprising, cooking the pieces, whereupon the pieces exhibit a grease out attribute.

15. The method of claim 13, further comprising adding a second fat during a later stage of extrusion to establish fat pockets in the pieces.

16. The method of claim 1, wherein high fat extruded protein product constitutes a meat analog on pizza.

17. A high fat extruded protein product including:
a blend of plant proteins including
soy protein,
wheat gluten, and
a grain or starch-based ingredient; and
at least 15-23% total fat by weight, wherein upon cooking the protein product, the protein product exhibits a grease-out effect.

18. The high fat extruded protein product of claim 17, further comprising meat wherein the meat constitutes no greater than 30% by weight of the high fat extruded protein product and the blend of plant proteins constitutes at least 40-50% by weight of the high fat extruded protein product.

19. The high fat extruded protein product of claim 18, wherein at least part of the total fat is from infused oil.

20. The high fat extruded protein product of claim 19, wherein at least part of the total fat is from tempered lard.

21. The high fat extruded protein product of claim 20, wherein at least part of the total fat is from hard fat which establish fat pockets in the protein product.

22. The high fat extruded protein product of claim 17, wherein the grain or starch-based ingredient constitutes rice flour.

23. The high fat extruded protein product of claim 17, wherein high fat extruded protein product constitutes a meat analog on pizza.
